(19) United States
(12) Patent Application Publication
(10) Pub. No.: US 2019/0041519 A1
(43) Pub. Date: Feb. 7, 2019

(54) DEVICE AND METHOD OF OPTICAL RANGE IMAGING

(71) Applicant: Oyla Inc., Palo Alto, CA (US)

(72) Inventors: Ralph Spickermann, Redwood City, CA (US); Srinath Kalluri, Palo Alrto, CA (US)

(73) Assignee: Oyla Inc., Palo Alto, CA (US)

(21) Appl. No.: 16/054,764

(22) Filed: Aug. 3, 2018

Related U.S. Application Data
(60) Provisional application No. 62/541,680, filed on Aug. 5, 2017.

(51) Int. Cl. G01S 17/89; G06T 7/521; G01S 17/08; G01S 17/93

(52) U.S. Cl. CPC G01S 17/89; G06T 7/521; G06T 2207/10028; G01S 17/93; G01S 17/08

(57) ABSTRACT

An optical device creates a 3D image of a volume of interest comprising horizontal, vertical, and distance information for each voxel. An illumination beam director and an imaging beam director are synchronized to each point to a selected, arbitrary, dynamically selectable reduced field of view, within a total field of view. Each reduced field of view is illuminated at once by a modulated continuous wave light source; and is imaged at once, using a pixel-array image sensor comprising time-of-flight for each of at least 8,000 pixels. The device sequences through 4 to 600 reduced fields of view until the total field of view is imaged. The device is free of rotating mechanical components. The pixel-array image sensor demodulates synchronously with the light source. Modulation frequency and sensor integration time are dynamically adjusted responsive to a desired volume of interest or field of view.

This application claims priority to and benefit of U.S. provisional application number 62/541,680, filed 5 Aug. 2017, with first named inventor Ralph Spickermann.

### FIELD OF THE INVENTION

This invention is in the field or optical image ranging devices, such as LIDAR.

### BACKGROUND OF THE INVENTION

Devices such as LIDAR are useful for autonomous vehicles and other applications to create a three-dimensional (3D) representation of elements within a volume of space around the device. The three dimensions are nominally horizontal, vertical, and distance. Prior art automotive LIDARs use parallel laser beams and spinning optics. They are expensive, slow, bulky and unreliable. Prior art consumer devices, such as Microsoft® Kinect® create 3D image. However, they are limited both by maximum distance and a limited field of view.

An additional weakness of the prior art is that the devices may not be arbitrarily directed at a region of interest smaller than the full scanned volume, or that a tradeoff between two parameters may not be dynamically selected.

Yet another weakness of the prior art is performance is limited when eye-safe conditions are required.

Additional weakness of the prior art includes low reliability and high maintenance of laser-based imaging devices and devices that use large rotating components. Yet another weakness is high cost.

### SUMMARY OF THE INVENTION

This invention overcomes the weaknesses of the prior art. A pair of synchronized beam directors, or beam pointers, are used, in in the illumination path and in receive path, such that each beam director is looking a same reduced field of view. A total field of view, encompassing a desired volume of interest, is comprised of a set of reduced fields of views, such as 2 to 40. A continuous wave light source is modulated by a signal that is also used to synchronously demodulate, and then detect or measure received light in a pixel-array image sensor that includes time-of-flight detection for each pixel.

### BRIEF DESCRIPTION OF THE DRAWINGS

FIG. 1 shows a schematic view of light paths.

FIG. 2 shows reduced fields of view within a total field of view.

FIG. 2 shows prior art.

### DETAILED DESCRIPTION OF THE INVENTION

Exemplary, non-limiting embodiments are described below.

A goal of the invention is to create a data set comprising a “3D point cloud,” where each point comprises X and Y locations (or azimuth and elevation angles) and a distance, for a desired volume of interest, by using a series of reduced fields of view.

Distance ranging devices, including prior art LIDAR, emit light from the device, which then bounces of an object in the volume of interest and returns to the device, where it is detected. Some prior art devices use either a very narrow laser beam, which is scanned via rotating optics, detecting a single point at time, for each laser beam employed, until the entire volume of interest is scanned. Other prior art devices use a “flash,” with a bright light pulse, which covers the total volume of view. Flash devices have a resolution depending on the number of pixels in a receiving light sensor chip. Flash devices generally have a relatively short range. Both types of prior art devices have only a single field of view, which includes the volume of interest.

Embodiments of this invention are free of a macro-mechanically rotated laser beam.

Prior art laser ranging devices and flash devices typically have unsafe exposure levels of irradiated light power at a human retina, as defined by ANSI Z136.1-1993. People may not “see a flash” if the light is infrared, but that does not make the device eye-safe.

An embodiment of this invention uses a continuous wave light, projected over a much larger area than a pointed laser beam, such as more than 0.0001 steradians. Because light from the device is distributed over a larger area, or transmitted through engineered diffusers, the device is eye-safe.

A 2D, or pixels array, sensor chip typically has individual light sensors, as pixels, arranged in a grid, although non-grid arrangements are also possible. The sensor chip may have a specified resolution, such as 320×240 pixels. However, this stated resolution may be mode dependent or application dependent, or definitionally flexible. For example, some of those pixels may be for calibration, or used as a guard band. This chip might have a higher internal physical pixel count but offers outputs at the specified resolution. Or, the chip might have a lower internal physical pixel count and synthesize pixels via interpolation. In addition, pixels may be paired or placed into blocks, thus offering, “programmable resolution.” In addition, some parts of the chip may be turned off, not used, or programmed to operate in a different mode than other parts of the chip. Thus, one needs to be cautious in interpreting such terms as “one pixel,” as the exact, correct interpretation may be context dependent.

Determination of a location of a point on an object, relative to a ranging device, generally requires combining information about the position of a beam director, and the location of a pixel on the imaging chip. In addition to the three-dimensional geometry, calibration data and non-linear factors may be included in the determination. Generally, a total field of view is assembled from individual reduced fields of view. In some embodiments of this invention, each reduced field of view is continuous and imagery in the reduced field of view is acquired simultaneously.

Prior art laser ranging devices and flash devices may have unsafe exposure levels of irradiated light power at a human retina, as defined by ANSI Z136.1-1993.

Because embodiments of this invention use continuous wave light, projected over a relatively much larger area than a laser, such as more than 0.0001 steradians, the device is eye-safe.

An embodiment uses a series of reduced fields of view to make up a total field view, where the reduced fields of view may be acquired in any order, and any reduced field of view may be acquired at an arbitrary, dynamically selectable, time.

Sensitivity of a device is often related to a maximum range of the device, such as 100 or 200 meters. Embodiments may increase sensitivity by increase the integration time for received light, similar to the length a conventional camera exposure time. Such a time we call a dwell time, because the optics of the system must dwell at one reduced field of view during this integration time. Embodiments have any arbitrary, dynamically selectable, dwell time, which may be selected uniquely and dynamically for each reduced field of view.

Although steradian as a measure of solid angle is generally portrayed as a cylindrical cone with an apex, it is also useful as a measure of any total portion of a sphere illuminated or imaged. For example, a shape of an illumination may be a rectangle, rather than a circle. When we refer to a “total solid angle,” we mean the total portion of the virtual sphere being illuminated or imaged, irrespective of the shape of the illumination or image area. A weakness of “beam spread,” as a similar unit of measure, is that it does not, by itself, address non-circular image areas.

In traditional optical systems, such as used for a common photograph, a field of view is defined by the focal length of a lens. Such a field of view is inherently continuous, even if, in practice, the limits of film grain size or pixel size of a digital sensor create quantification. A larger field of view, such as a satellite image of a state, may be composed of many smaller, or “reduced,” fields of view, each such reduced field of view taken at once, which are then stitched together or synthesized into a “total field of view.” Note that in such a case the “total field of view” is artificial, and not continuous as taken, in the sense that it does not correspond to any lens. Such reduced fields of view, may, in principle, be acquired in any order at any time. These reduced fields of view may overlap; nonetheless, we refer to each such originally photographed reduced field of view as “continuous,” similar to a common photograph. In contrast, an imaging system might consist of multiple cameras, each camera simultaneously taking non-adjoining images or acquiring non-adjacent points. Later all such images or points are re-ordered and stitched together appropriately. In such a system, we say the image or points as acquired are not continuous, even if they can be later re-assembled into an effectively continuous image. Thus, the individual received dots in a laser scanning system are neither reduced fields of view nor continuous. Nor are multiple scan line from a laser scanning system either continuous or a reduced field of view. Intervening scan lines prevent data as acquired from being continuous or a reduced field of view.

An optical ranging system, with respect to a single pixel, group of pixels, imaged object, or a field of view, ideally generates a distance, a set of distances, or a range of distances. However, for various reasons, the optical ranging system may not be able to produce such a distance. A target may be too far away, or ambient light may be too bright, or a signal may not rise above a noise threshold, or a portion of a sensor may be disabled or unused. In such a case, we say that there is, “no usable distance.” Equivalently, we might say the distance has, “no value.”

A distance might be a scalar, such as “10 meters,” and it might apply to a single pixel or a group of pixels. The distance might be a range, such as, “8-12 meters.” Such a range might apply to a single pixel, where the range reflects a usable resolution or precision of measurement. Or, it might apply to a group of pixels where some pixels are farther than other pixels in the group. In addition, a distance might be a limit, such as “less than one meter,” or, “more than 200 meters.” In all these cases, we still refer to this metric as, “a distance,” even it is more complex than a single scalar. Additionally, a distance may also comprise a statistical confidence, such as in the range of 0-100%. (Although with a confidence of 0%, it would be appropriate to say this distance has, “no value.”) A distance might also have a statistical spread, such as a value for one sigma.

A 2D sensor chip that includes distance sensing is even more complex with respect to resolution. For example, distance resolution may be different than spatial resolution. For example, a chip might have a 2×2 group of pixels, each of which captures and outputs a luminous intensity; while distance information is available only for the group. In addition, there may be bleed or blur between adjacent pixels, so a true spatial resolution, or true distance resolution, may be less than implied by the number of pixels. Therefore, caution is needed when referring to “pixels.” A spatial pixel may not be the same as a distance pixel, and the number of pixels in an image may be variable, depending on both mode and definitions.

A luminous intensity of one pixel may be a gray scale value, or a binary value, or “no value.” Similarly, a distance of one pixel may be a scalar, a range (as discussed elsewhere herein), a binary value, or “no usable distance.”

In another embodiment, a stereo optical camera is also part of the embodiment elements. Such an optical camera, which may be integrated or two separate cameras separated by a baseline, looking at the same or overlapping reduced fields of view, may be used to determine distance from the device to an object. Typically, such traditional optical cameras identify objects much larger than a single point, by correlating an outline (or other representative aspect of the object) between its relative positions in the two images. A novelty is that optical cameras, stereo or single-image, are directed to the same reduced field of view as the optical range imaging device. That is, the useful, or as-used, view by the optical camera is smaller than the total field of view, and is the same as or overlaps the reduced field of view as the optical range imaging device,

Detection of a distance to an object of interest suffers from potential ambiguity because the object may be farther away than the time of flight of one cycle of the modulation frequency. In yet another embodiment, an optical camera, looking at the same object of interest, in one or multiple reduced fields of view, may be used to disambiguate distance to the object, using, for example, stereo imaging, or object recognition, such as using the apparent size of a recognized vehicle or stop sign. In plain English, the optical camera may determine a coarse distance and an embodiment the ranging device a fine distance, in either order.

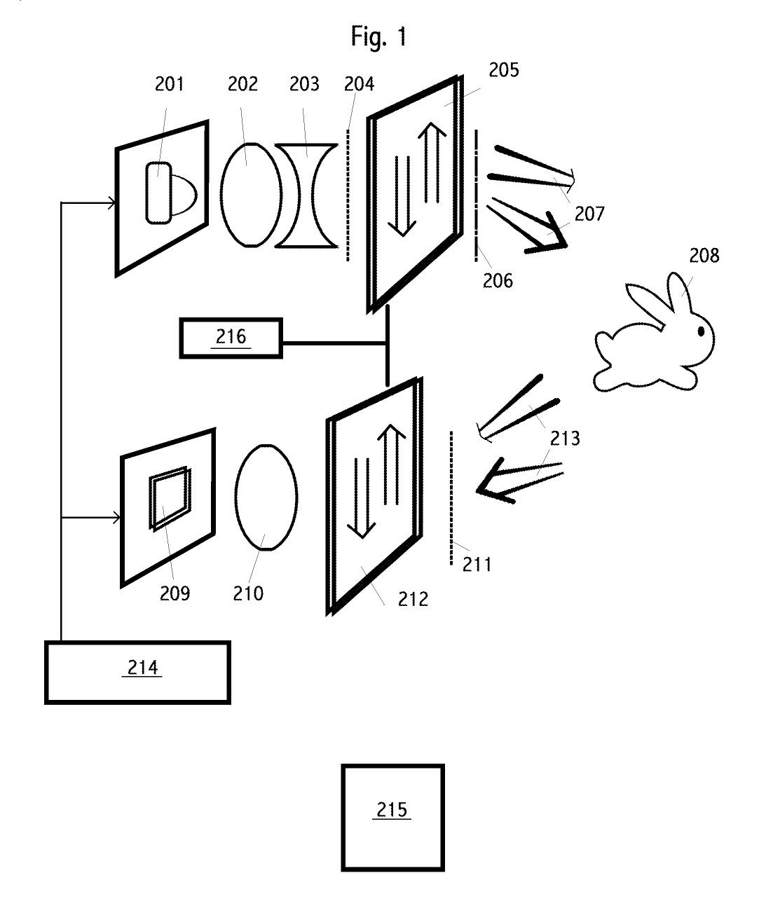

Turning now to FIG. 1, we see a schematic view of an embodiment of light paths. A light source 201 is continuous wave, not pulsed. It may be one or more LEDs, one or more solid-state lasers, or another type of light source. Exemplary wavelengths are 600, 850, 904, 940 and 1550 nanometers (nm). The light source 201 is modulated by modulator 214. Modulation might be amplitude modulation by a sine wave, a square wave, or another continuous waveform. In another embodiment, modulation is frequency modulation, or both amplitude and frequency modulation. In yet another embodiment, modulation is polarization angle. Modulation frequency may be fixed or dynamically selectable, such as programmable. Modulation signals may be adjusted so that, first, emitted light is modulated more linearly with a desired modulation signal shape, and second, received electrical signals from each pixel is more linear with received light. Therefore, the modulation and demodulation signals may not be the same, although they will be synchronized. A light source may be external to the device, in which case the device is adapted to or configured to receive light from a modulated external light source.

An exemplary embodiment includes a collimator 202, a beam spreader 203, and a spectral filter 204. These elements may be separate, combined, or in a different order. For example, a spectral filter may be a coating on another optical element. A collimator or beam spreader may be part of the light source.

Element 205 is an illumination beam director, which points the spread beam to cover a desired reduced field of view 207. A filter or additional beam spreader 206 may be used, such as an engineered diffuser or diffraction grating; Device 206 may be incorporated into the illumination beam director 205. Device 206 may be an aperture lens. The beam director is controlled by a beam director driver, 216 which synchronously also drives the receive beam director. As discussed elsewhere herein, reduced fields of view may be selected arbitrarily, in any order, with any length of dwell time.

An object of interest 208 bounces illumination light 207 back to the device 213. Return light passes through an optional filter 211, then to a receive beam director 212. A receive beam director may be the same, similar or different than the illumination beam director, but is typically similar. Receive light then passes through a lens 210 to a pixel array image sensor 209, which also includes time-of-flight sensing for each pixel, as discussed elsewhere herein. There may be additional element in the receive path, such as collimators, telescopic optics, spectral filters, antireflection filters, light gates, aberration correction elements, and the like. The beam director driver drives receive beam director 212 synchronously with the illumination beam director 205, so they both see the same reduced field of view. The two beam directors differ in use of spectral filters. The two beam directors may differ in the use of an exit aperture lens, closest to the volume of interest. The two beam directors may differ in the use of an exit engineered diffuser, closest to the volume of interest.

The pixel array image sensor 209 demodulates the received light using a signal from the modulator 214, such that the light modulate and demodulation are synchronous.

The illumination beam director 205 and the receive beam director 212 are free of rotating optics and macro-mechanical devices to change azimuth and elevation, such as a turret or periscope, or a mirror mounted on a galvanometer. They may comprise various elements to participate in beam steering including one or more 1D or 2D MEMS devices; PZTs (piezoelectric transducers); voice coils; electrostatic comb drive; electrostatic actuators; magnetic actuators; electroactive polymers; electronically addressable LCD light gates; addressable polarizers; lens arrays; beam splitters; mirrors; prisms; quarter-wave plates; half-wave plates; phase plates; Risley prisms, and lenses. More than one device that provides non-rotating mechanical motion, include MEMS devices, PZTs, voice coils, electrostatic comb drive, and electroactive polymers may be used sequentially in a light path to act as “multipliers” in expanding a narrow beam angle range from a single into a wider beam angle range. In addition, multiple devices may be use to achieve beam steering in both X and Y (or azimuth and elevation). Folded optics may be used. In one embodiment, an addressable polarizer comprises individual portions of a reflective mirror, where each portion may be electronically enabled to either rotate a polarization angle or non-rotate a polarization angle (or select from two different polarization angles). In conjunction with one or more polarizers, a set of electronically selectable light gates or polarization segments may be created. These filters and gates then, as a group, along with other optics in the embodiment, select which reduced field of view is selected. Such polarizers/reflectors may be cascaded to significantly increase the number of reduced field of views. For example, device might select one of four gates, which then pass through another device with four gates, producing one of sixteen possible beam angles. In another embodiment, one or more 1D or 2D MEMS device select “fine” control and electronically selectable gates or polarizers provide “coarse” control of beam angle. Such elements, including MEMS and electronically addressable devices, may direct light to a segment mirror or prism, that then controls the number of times the light bounces between two reflective devices; that is, when light hits a gap in the device it passes through; otherwise it reflects. In this way, a small change in beam angle may be part of a larger beam angle change. Another device that implements mechanical motion uses a temperature coefficient of expansion, along with a heater. If rotating Risley prisms are used, then a device is not “free of rotating mechanical elements.” Suitable maximum horizontal angle in a total field of view is: 5°, 7.5°, 10°, 15°, 20°, 30°, 45°, 60°, 75°, 90°, 120°. Note that for larger angles, there may need to be more than one beam director (a “set” of beam directors) for both illumination and imaging. For this embodiment, there is a dynamically selectable first beam director (closest to the light source or image sensor, respectively) that directs the beam to a second beam director (that is, closest to the volume of interest) in this set.

Device 215 is a controller, such as a programmable device. Such a controller may be all or partially remove from the device, in which case the device is adapted to or configured to accept control signals. A functional device also comprises a case or substrate and a power source, not shown.

Of key importance is that modulation signal, such as from modulator 214 connects operatively to the light source, potentially via a driver, and to the pixel array image sensor with time-of-flight 209, such that modulation of the light source and demodulation to determine time-of-flight are synchronous. Also of key importance is that a beam director driver 216 drives both the illumination beam director 205 and the receive beam director 212 such that they point at the same reduced field view.

Received light passes through the receive beam director 212 then passes through one or more focusing lenses or collimating lenses 210, which focuses an image of the reduced field of view onto the pixel array image sensor 209. Pixels in the image sensor are typically but not always arranged as rectangular grid of rows and columns. Other arrangements may be used, such as a hexagonal grid, or a pattern roughly circular in shape. Pixels are typically square. Other pixels shapes may be used, such as rectangular. Pixel size is typically the same for all pixels. Other pixels size variations may be used, such as larger pixels near the perimeter and smaller pixels near the center (or the reverse). An advantage of rectangular pixels shape is it may more closely match a desired field of view shape, or which might be used to implement a different vertical resolution versus horizontal resolution. An advantage of a hexagonal array is that hexagonal pixels more closely match a more optically natural field of view shape of circular (i.e., conical beam). An advantage of variable pixel size is to be able to trade off resolution with light sensitivity at different portions of a field of view. A higher special resolution near a center of a field of view more closely resembles human eyes. Yet another feature of the image sensor, in some embodiments, is the ability to dynamically link adjacent pixels into pixel groups. This can increase sensitivity or improve signal-to-noise ratio (S/N) at the expense of reduced spatial resolution. This may be used to dynamically increase range, which may be used selectively for only some reduced fields of view. Or may be used to change, selectively, range for a single field of view. The number of pixels in an image sensor may be in the range of 40 to 40 million, or the range of 100 to 10 million, or the range of 400 to 1 million, or the range of 25,000 to 1 million. In some embodiments, pixels may be arranged in blocks, where each block may have integration times and read-out times controlled independently. This is useful if only a subset of a field of view is desired, which may improve overall device scan speed at the expense of ignoring areas of a total or reduced field of view. That is, in one embodiment, a non-rectangular reduced field of view or total field of view may be selected, such a based on a known or suspected non-rectangular region of interest. Yet another use of such blocks is to overlap, or stagger, integration time with read-out time. Such a feature may be use to dynamically determine a velocity of an object of interest more quickly than repetitive reception of a complete reduced field of view. In yet another embodiment, a pixel or group of pixels may have multiple integration time windows, with no readout in between these time windows. This permits increased sensitivity, improved signal to noise, or improved range at the expense of slower data acquisition (time resolution) for that pixel or group. This is particularly valuable when it is desirable to parse a reduced field of view into FoV “segments” where the tradeoff between sensitive (e.g., range) and data acquisition speed is then dynamically selectable in both time and spatial position. In one embodiment, overlapping reduced fields of view are combined with pixel blocks. For example, consider two overlapping reduced fields of view. Pixel blocks for the overlapping areas have one set of operating parameters, as described herein, while the non-overlapping areas have a different set of operating parameters. Thus, the overlapping areas might then have increased range or increased special resolution. Note that pixel blocks may align with segments of a field of view, but not necessarily.

The pixel array image sensor also comprises time-of-flight detection, or ranging, on a per-pixel (or pixel group) basis, typically by quadrature sampling (e.g., four samples per waveform) received light at each pixel. The modulated signal used to modulate the light source 201 is also used, directly or indirectly, to demodulate the received light at each pixel in the image sensor. The exact shape of the demodulation waveform may not be identical to the modulation waveform for numerous reasons. One reason is that the neither the light source 201 nor the receiving pixels in the image sensor 209 are perfectly linear; waveforms may be shaped to correct or improve the non-linearities of either the light source 201 or the receiving pixels, or both. Another reason is to raise signal levels above a noise floor. The modulation signal or and the demodulation signal are the same frequency and phase matched. Their phases may not be perfectly identical, intentionally, due to delays both in the electronics and in the optical paths. Such demodulation is typically referred to as synchronous, as known to those in the art. Modulation and demodulation may also be “boxcar,” that is using square waves, where the intensity is nominally binary valued.

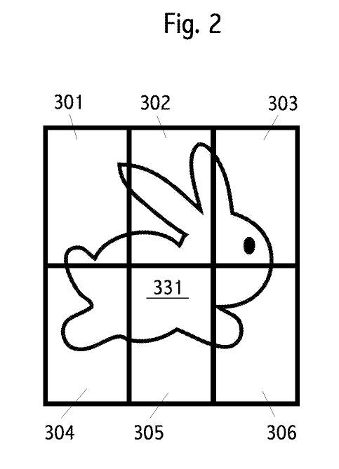

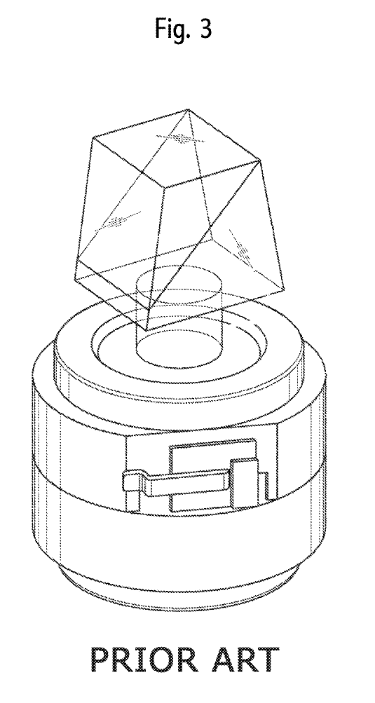

Turning now to FIG. 2, we see a simplified representation of multiple fields of view. An object of interest is shown 331. The total field of view comprises six contiguous reduced fields of view, 301 through 306. The arrangement shown may be described as 3 by 2. A suitable number of reduced fields of view is in the range of six to 600. Another suitable range is 20 to 150. Another suitable number is 40, arranged as five rows of eight. This figure shows reduced fields of view as rectangles. Ideally, reduced fields of view are square, but many other shapes are possible. This figure shows reduced fields of view arranged in a grid, but other patterns are possible, such as a hexagonal array, or any arbitrary, dynamically selectable, arrangement. A novelty of this invention is the ability to place reduced fields of view anywhere within the total field of view.

A novel feature of embodiments is the ability to image any reduced field of view at an arbitrary, dynamically selectable, time, and thus scan through multiple fields of view in any order. In addition, a novel feature is the ability to use different operating parameters for different fields of view. For example, a lower modulation frequency or longer dwell time (effectively: exposure time or light integration time) to achieve a longer maximum range. As another example, pixels in the pixel array light sensor may be grouped into sets, permitting higher sensitivity at the expense of lower point resolution. Changing from one selected reduced field of view to another selected field of view may take any amount of time greater than a predetermined minimum beam move time. Dwell time may be any dynamically selectable time interval greater than zero.

The size, that is, the solid angle, of reduced fields of view may be fixed; that is, predetermined and not dynamically adjustable.

In one embodiment, illumination light is spread over an illumination shape, which may be symmetric: that is, the azimuth and elevation are the same, such as for a circular illumination shape. Or the illumination shape may be asymmetric, such as an ellipse or rectangle. In this embodiment, many spots of interest are illuminated simultaneously.

A reduced field of view is not diffraction limited. It is not effectively one point.

Turning to FIG. 3, we see exemplary prior art. Shown is a laser LIDAR, with a pair of rotating prisms on top.

### Exemplary Characteristics

An image sensor may use CMOS, photodiodes, CCD technology or other light sensing technology. Herein is described only one non-limiting embodiment

Some embodiments incorporate the following:
Usable distance of 200 meters, or better
Angular resolution of 0.1°, or less; ideally 0.015°
Field of view of 100° horizontal by 30° vertical, or larger
Coverage of entire field of view in 1 second or less, such as 0.2 seconds
Acceptable S/N with 10% reflectivity of the object imaged
Exemplary sensor: epc611 or epc660 by Espros Photonics AG (St. Gallerstrasse 135, CH-7320 Sargans, SWITZERLAND)

### Incorporation of Matter in a Provisional Application

This application incorporates by reference all matter in the above named US provisional application, including:
beam divergence angle of 0.015 degrees
320×240 QVGA 2D image sensor with ToF
range of 100 meters
two stepper motors to drive Risley prisms using plastic gears
eye-safe irradiance intensity at the fovea of 150 watts/meter-squared
at a range of 200 meters, with a 4 degree beam spread, a single pixel is 35×35 cm,
illumination power is +31.4 dBm; −9.6 dBm at a target, and −95.6 dBm at the receive chip.
with a 4 degree lens, a ToF embodiment has 0.1 degree resolution, or 40 pixels per 4°, at 850 nm
905 or 940 nm wavelength provides +6 dBm, 4 times less interfering sunlight
a lateral camera provides course stereo distance measurement to increase range of device, and resolve ambiguity due to time of flight exceeding one modulation cycle.
lateral camera may be located to the side of an embodiment, with respect to a target
a three degree beam step; 5 frames×40 ms each, 150 ms scan time, 26 ms shutter (dwell); resolution of 0.015 degrees, or 2.6 cm at 100 meters. At 200 meters, resolution of 0.05 degrees
5 frames a5 ms each=25 ms scan time; 1 ms shutter; 5% reflectivity, +3 dB “flash, operating as a short term, “high beam.”
An LCoS (liquid crystal on silicon) embodiment for the illumination subsystem comprises:
a modulated, collimated light source hitting an optional 2D or 1D MEMs mirror, then to
an optional fixed mirror or prism for folded optics; then to
an LCoS addressable polarity switching spatial mirror, that addressably and programmably, has elements that that either change or do not change the polarization of reflected light, with a range of addressable elements such as 2×4
an optional MEMS mirror may select one “bank” of LCoS elements such as a bank of 1×4 or another bank of 1×4.
a polarization selective mirror, such as wire grid on glass
a variable number of optical bounces between the LCoS and the polarization selective mirror, in the range of zero to four bounces, as determined by which elements of the LCoS are turned on, and optionally by the orientation of the MEMS, then to
a segmented lens array such as four segments or as eight segments arranged as 2×4, with an exemplary pitch of 1 mm
number of segments in the segmented mirror matches the number of selectable bounces; that each, for each possible light path there is on segment of the segmented lens used in the light path, then to
a large, aperture lens, then
exits the device as the illumination beam, subtending a reduced field of view.
the imaging system is similar, but the optical path is reversed with an image sensor with ToF at the end of the imaging optical path
segments selected in the LCoS are the same for the illumination path and the imaging path
MEMS orientation, if used, is the same for the illumination path and the imaging path

### Additional Embodiments

One embodiment is free of any non-solid-state moving mechanical elements.

One embodiment comprises a 3D point cloud for one reduced field of view comprising 50,000 or more points.

One embodiment comprises a 3D point cloud for one reduced field of view comprising 50,000 or more points.

One embodiment is free of resonant mechanical components, wherein the resonance is required for the operation of the device.

One embodiment comprises the limitation: “the total field of view comprises at least 4 and at most 600 reduced fields of views.”

A claimed embodiment includes:

A system of optical ranging using the device of claim 1 (as filed) further comprising:

a human associated with the device of claim 1;

wherein operation of the device of claim 1 assists in the safety, security or identification of the human.

### Definitions

Ambiguous v. unambiguous distance—Objects that are farther away than the distance corresponding to the time of flight of one cycle of the modulation frequency produce an ambiguous distance. Disambiguation is the process of identifying in which of several distance “bins” the object resides.

Attributes of an object in a field of view—includes without limitation: size, shape, speed, velocity, distance, range of distance, reflectivity, relationship to another object, relationship to the device or a vehicle comprising the device, and rate of change of any attribute.

Boxcar integrator—A sensor integrates light during a period of reflected light from an object, where the light source is the device, and then de-integrates light received during a time period when the device is not illuminating the subject. In this way, background light is subtracted from the total received light, or equivalent value. Integration and de-integration times may not be same, in which they are suitably scaled.

MEMS—A microelectromechanical system, or MEMS, is considered a “solid-state” device, unless otherwise stated.

Risley prism—Risley prisms are well known in the art. They usually comprise a pair of optical wedges, plus a means to allow rotation of each wedge individually. However, terminology in the art is not consistent. Sometimes, “a Risley prism” refers to the pair of optical wedges. Other times, each wedge is referred to as, “a Risley prism;” which is our preferred terminology, herein. However, selecting which interpretation should be used is context dependent and a reader must careful to identify the correct interpretation.

Synchronized—with respect to the two beam directors, refers to them both pointing at the same reduced field of view.

“Prior art,” including in drawings, does NOT admit to verbatim prior art, but rather there may aspects of an element that are known in the prior art. The actual similar or corresponding element in an embodiment may or may not consist of the prior art. In many embodiment the so identified “prior art” may require extensive or non-obvious modification or additions.

Use of the word, “invention” means “embodiment,” including in drawings.

Ideal, Ideally, Optimum and Preferred—Use of the words, “ideal,” “ideally,” “optimum,” “optimum,” “should” and “preferred,” when used in the context of describing this invention, refer specifically to a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

All numerical ranges in the specification are non-limiting examples only.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substitution thereof to any and all other device claims, including all combinations of elements in device claims.

We claim:

1. An optical imaging system comprising:
an illumination subsystem comprising;
a continuous wave light source;
a first beam director, comprising a total field of view, in turn comprising a plurality of reduced fields of view;
a light modulator adapted to modulate the continuous wave light source;
an imaging subsystem comprising;
a two-dimensional (2D) pixel-array light sensor comprising a time-of-flight output for each pixel;
a second beam director, comprising the total field of view;
a light demodulator, wherein the light demodulator is synchronous with the light modulator;
a controller operatively connected to the first beam director, the second beam director, the continuous wave light source, and the pixel-array light sensor;
wherein the controller directs the first beam director and the second beam director to a first selected reduced field of view;
wherein modulated light from the continuous wave light source passes through the first beam director toward a volume of interest;
wherein reflected light from an object in the first selected reduced field of view passes through the second beam director to the pixel-array light sensor, where it is imaged at once, and then output as a three-dimensional point cloud comprising points within the reduced first selected reduced field of view, comprising at least 300 points;
wherein changing from any first reduced field of view to any second selected, different, reduced field of view is at an arbitrary, dynamically selectable time;
wherein the controller sequences the first and second beam directors through an arbitrary, dynamically selectable sequence of reduced fields of view until the entire total field of view is imaged;
wherein the optical imaging system then outputs a three-dimensional point cloud comprising points within the total field of view.

2. The optical imaging system of claim 1 wherein:
each of the plurality of reduced fields of view comprises a total solid angle greater than 0.0001 steradians.

3. The optical imaging system of claim 1 wherein:
the total field of view comprises at least 2 and at most 40 reduced fields of views.

4. The optical imaging system of claim 1 wherein:
each reduced field of view is continuous.

5. The optical imaging system of claim 1 wherein:
the plurality of reduced fields of view are contiguous.

6. The optical imaging system of claim 1 wherein:
any one of the plurality of reduced fields of view may be unchanged for any time period, a dwell time, greater than zero.

7. The optical imaging system of claim 1 wherein:
a time delay from any first selected reduced field of view to any second selected reduced field of view in the plurality of reduced fields of view may be any arbitrary time greater than a pre-determined time period.

8. The optical imaging system of claim 1 wherein:
the first beam director and the second beam director are free of any rotating macro-mechanical elements larger than one centimeter.

9. The optical imaging system of claim 1 wherein:
a maximum permissible exposure (MPE) of irradiated power, from the optical imaging system, to a human eye within the total field of view, does not exceed the limits set by ANSI Z136.1-1993, for 0.25 second.

10. The optical imaging system of claim 1 wherein:
a maximum permissible exposure (MPE) of irradiated power, from the optical imaging system, to a human eye within the total field of view, does not exceed 2.5×10̂-3 watts/cm̂2.

11. A method of optical ranging using the device of claim 1 comprising the steps:
(a) pointing both the first and second beam directors at a first desired reduced field of view;
(b) illuminating the first desired reduced field of view with modulated continuous wave light;
(c) imaging at once, using the pixel-array light sensor, reflected light from objects in the first desired reduced field of view, and simultaneously detecting a distance for each pixel;
(d) generating a three-dimensional point cloud with 300 or more points.

12. The method of optical ranging of claim 11 comprising the additional step:
(e) repeating steps (a) through (d) for additional reduced fields of view until the entire total field of view is imaged.

13. The method of optical ranging of claim 11 comprising the additional step:
(f) repeating steps (a) through (d) for an arbitrary, second, different, desired reduced field of view,
wherein the modulation frequency is altered and a dwell time is altered for the second reduced field of view respect to the first reduced field of view.

14. The method of optical ranging of claim 11 comprising the additional step:
(g) repeating steps (a) through (d) for the first desired reduced field of view,
wherein the repeating is responsive to one or more attributes of an object in the first desired field of view.

15. A system of optical ranging using the device of claim 1 further comprising:
a vehicle comprising the device of claim 1;
wherein operation of the device of claim 1 assists in the operation of the vehicle.
